(19) United States
(12) Patent Application Publication
(10) Pub. No.: US 2014/0343999 A1
(43) Pub. Date: Nov. 20, 2014

(54) RISK-AWARE PROJECT SCHEDULING TECHNIQUES

(71) Applicant: Oracle International Corporation, Redwood Shores, CA (US)

(72) Inventors: Alex Jae Hyhn KIM, Toronto (CA); Edward Michael SITARSKI, Toronto (CA); Jinliang CHANG, Toronto (CA)

(73) Assignee: Oracle International Corporation, Redwood Shores, CA (US)

(21) Appl. No.: 14/213,527

(22) Filed: Mar. 14, 2014

Related U.S. Application Data
(60) Provisional application No. 61/786,428, filed on Mar. 15, 2013.
(60) Provisional application No. 61/786,441, filed on Mar. 15, 2013.
(60) Provisional application No. 61/786,451, filed on Mar. 15, 2013.

(51) Int. Cl. G06Q 10/06

(52) U.S. Cl. CPC G06Q 10/06313; G06Q 10/0635
USPC 705/7.23

(57) ABSTRACT

A method, system, and computer program product for reducing risk and schedule during workflow scheduling in asset-intensive projects. A subject project schedule comprises a plurality of tasks wherein at least some of the tasks have an initial resource demand. A critical path through the plurality of tasks is identified. Alternate resources deemed to be possible alternatives to the initial resource demand are identified, and the risk of using the alternate resource is assessed by calculating a first path risk value (e.g., corresponding to assigning initial resource demand to the critical path) and calculating a second path risk value (e.g., corresponding to assigning the first alternate resource to the critical path). The impact of selecting one or another risk-assessed resource is assessed, and a resource having a lower risk is selected. Further processing includes adjusting at least one task on the critical path to use the selected lower risk resource.

### RELATED APPLICATIONS

The present application claims the benefit of priority to co-pending U.S. Patent Application Ser. No. 61/786,428 entitled “METHOD AND SYSTEM TO IMPLEMENT SUPPLY CHAIN PLANNING FOR ASSET INTENSIVE APPLICATIONS” (Attorney Docket No. ORA130840-US-PSP), filed Mar. 15, 2013; and the present application claims the benefit of priority to co-pending U.S. Patent Application Ser. No. 61/786,441, entitled “METHOD AND SYSTEM TO IMPLEMENT PLANNING FOR ASSET INTENSIVE APPLICATIONS” (Attorney Docket No. ORA130841-US-PSP), filed Mar. 15, 2013; and the present application claims the benefit of priority to co-pending U.S. Patent Application Ser. No. 61/786,451, entitled “METHOD AND SYSTEM TO ANALYZE CRITICAL PATHS FOR ASSET PLANNING” (Attorney Docket No. ORA130842-US-PSP), filed Mar. 15, 2013 each of which is hereby incorporated by reference in their entirety.

The present application is related to U.S. patent application Ser. No. ______, entitled “ASSET TRACKING IN ASSET INTENSIVE ENTERPRISES” (Attorney Docket No. ORA130840-US-NP) filed on even date herewith; and the present application is related to U.S. patent application Ser. No. ______, entitled “ASSET FORECASTING IN ASSET INTENSIVE ENTERPRISES” (Attorney Docket No. ORA130841-US-NP), filed on even date herewith, each of which are hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The disclosure relates to the field of workflow scheduling in asset-intensive projects and more particularly to techniques for risk-aware project scheduling techniques.

### BACKGROUND

Project management software has been a boon to organizations and their management teams. As projects become more and more complex, and as the number of personnel assigned to a particular task increases, so do the expenses of progressing through a series of project tasks toward project completion, and project managers are under increasing pressure to more quickly bring the project to completion. Project management software can observe dependencies between tasks (e.g., a task to “mount the engine” would need to be started not earlier than the completion of a predecessor task, “mount engine brackets”). Some project management software can predict a project completion date based on calculation of critical paths, and some project management software can even spread out resources so as to avoid over use of resources (e.g., “stretch-out” the schedule in accordance with a resource utilization metric). However, legacy project management techniques are unable to identify alternate resources and assess associated risks (e.g., availability risks, time-wise risks, etc.) when assigning resources to tasks (e.g., so as to reduce the critical path). Moreover, legacy project management techniques are unable to assess risk and break “ties” in order to discriminate between multiple candidate resources when assigning resources to tasks.

What is needed is a technique or techniques to schedule tasks in a manner that is sufficiently resource-aware and risk-aware so as to identify the resource demands of various tasks, and then to source the needed quantities and/or availability to paths so as to reduce the risks of achieving completion of the project on schedule.

None of the aforementioned legacy approaches serve to emulate real-world, risk-aware resource scheduling techniques for reducing critical paths. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for reducing critical paths using risk-aware project scheduling techniques.

Embodiments process a subject project schedule comprising a plurality of tasks to be performed over time, at least some of the tasks having an initial resource demand. Processing identifies a critical path through at least some of the plurality of tasks, and various techniques are used to identify a first alternate resource where the first alternate resource is deemed to be an alternative to the initial resource demand. Risk is assessed by calculating a first path risk value (e.g., corresponding to assigning an initial resource demand to the critical path) and further calculating a second path risk value (e.g., corresponding to assigning the first alternate resource to the critical path). The impact of selecting one or another alternative is assessed (e.g., by comparing the first path risk value and the second path risk value) and a resource having a lower risk is selected. Exemplary embodiments include adjusting at least one task on the critical path to use the selected alternative resource.

Various techniques are employed to achieve the foregoing, including identifying alternate resources based on time-wise availability of the alternative resource, and/or identifying availability of a resource from a project schedule other than the received subject project schedule.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A depicts an environment for implementing reducing critical paths using risk-aware project scheduling techniques, according to some embodiments.

FIG. 1B is a flowchart for dynamically adjusting a project schedule in accordance with reducing critical paths using risk-aware project scheduling techniques, according to some embodiments.

FIG. 1C1 is a diagram showing a time-wise feasible schedule as used in systems that implement reducing critical paths using risk-aware project scheduling techniques, according to some embodiments.

FIG. 1C2 is a diagram showing a resource-wise feasible schedule as used in systems that implement reducing critical paths using risk-aware project scheduling techniques, according to some embodiments.

FIG. 1D is a flowchart for evaluating risks of resource assignments as used in systems for reducing critical paths using risk-aware project scheduling techniques, according to some embodiments.

FIG. 2 is a use model diagram showing interactive uses of resource assignment logic as used in a system that implements reducing critical paths using risk-aware project scheduling techniques, according to some embodiments.

FIG. 3A is a screen display of a project schedule visualization as used in systems for reducing critical paths using risk- and risk-aware project scheduling techniques, according to some embodiments.

FIG. 3B is a screen display of a project critical path visualization as used in systems for reducing critical paths using risk-aware project scheduling techniques, according to some embodiments.

FIG. 3C is a screen display of an isolated critical path visualization as used in systems for reducing critical paths using risk-aware project scheduling techniques, according to some embodiments.

FIG. 3D is a screen display showing risky path visualizations as used in systems for reducing critical paths using risk-aware project scheduling techniques, according to some embodiments

FIG. 4 is a diagram of resource pool schema as used in systems for reducing critical paths using risk-aware project scheduling techniques, according to some embodiments.

FIG. 5 is a diagram of repair depot operations that exemplify techniques for reducing critical paths using risk-aware project scheduling techniques, according to some embodiments.

FIG. 6A is a block diagram of a system for reducing critical paths using risk-aware project scheduling techniques, according to some embodiments.

FIG. 6B is a flow diagram of a system for reducing critical paths using risk-aware project scheduling techniques, according to some embodiments.

FIG. 7 is a block diagram of a system for reducing critical paths using risk-aware project scheduling techniques, according to some embodiments.

FIG. 8 is a block diagram of a system for reducing critical paths using risk-aware project scheduling techniques, according to some embodiments.

FIG. 9 depicts a block diagram of an instance of a computer system suitable for implementing an embodiment of the present disclosure.

### DETAILED DESCRIPTION

Some embodiments of the present disclosure address problems pertaining to project scheduling and some embodiments are directed to resource-awareness in the context of project scheduling. More particularly, disclosed herein and in the accompanying figures are exemplary environments, methods, and systems for reducing critical paths using risk-aware project scheduling techniques in a repair depot context.

### Overview

A project manager might use project management software to predict a completion date for the project, and thus get an idea of when the project is possible to complete (e.g., based on the critical path), however legacy project management software is ineffective at automatically suggesting a shortest critical path that takes into account risk associated with assigning a particular resource. Further, legacy project management software is ineffective at offloading and/or sequencing and/or modeling changeovers (e.g., personnel rotations or equipment downtimes) and/or incorporating other real-world constraints in order to bring a project to completion “on time”.

An initial assignment of resources to a task might hypothetically satisfy the demands of that task at the time the initial assignment is made. However, as time progresses, events may cause the initially-assigned resources to become unavailable for the task at the scheduled start time of the task. In some cases, during the progression of the project, the initially-assigned resources (e.g., tools, equipment, human resources, etc.) might have been reassigned to a different project, or some initially-assigned resources (e.g., materiel or consumable) might have been taken from inventory by another project, etc. Naïve approaches fail to account for changes in the timing of availability of resources with respect to the start time of the task or tasks that need such resources in order to start and finish on the given schedule.

Further, other constraints and/or risk factors can factor into resource assignments, which constraints and/or risk factors are not considered by naïve approaches. When a resource (e.g., person or piece of equipment) switches from one job to the next, there might be a changeover event. A changeover event might require the resource to be refreshed, or a changeover event might involve operations (e.g., routine maintenance operations) to prepare the resource for a different process or to comport with changed-over engineering instructions. For example, for a “paint booth” resource when changing from white paint to red paint, a changeover may be necessary to prepare (e.g., purge, clean, etc.) the resource of the air-gun for the change in color. When moving from red to white a different (e.g., longer) changeover might be indicated so as to account for extra cleaning as may be required in going from a dark tint to a light tint. In some cases, changeover time greatly impacts the resource availability since the resource is effectively not available during the duration of the changeover. Such situational or attribute-based changeovers can be quantified and considered for accurate project scheduling. In some cases, the risk involved in a scheduling a resource determines which of a plurality of choices are good candidates, and which are less so. Thus, disclosed herein are techniques to periodically update tasks in a manner that is sufficiently resource-aware and risk-aware so as to identify the timing of resource demands of various tasks, and then to source the demanded resources to tasks such that the task can start on time and/or end on time and with the demanded resources available at the moment in time that they are needed.

In a resource-intensive setting, such as when projects involve many people and/or many pieces of equipment (e.g., construction vehicles, machines, test equipment, repair equipment, etc.) and/or materials that need to be available to start and finish tasks, each resource or asset has a cost of use or cost of depletion. In some situations, such costs can be calculated, and in some cases such costs are included in project accounting. In certain cases, such as in embodiments of the present disclosure, calculation and presentation of a project schedule is up-to-the-second resource-aware. Tasks that demand particular resources (e.g., the task “change the oil” would demand “four quarts of oil”) need the resource to be available at the time the task begins, and embodiments as disclosed herein serve to periodically monitor resource availability so as to plan that the demanded resources are available to the task when the task is scheduled to begin.

In another example, suppose a repair job (e.g., Job1) includes the task “change the brake pads”, and further suppose that the task “change the brake pads” requires the resource of a jack. In this setting, even though there might be a jack in the inventory or resource pool, the jack might be scheduled for use by another job (e.g., “Job2”) at the same time. Or the jack might be scheduled for use at a different time, but in a different location. In such a case, the task “change the brake pads” of Job1 cannot start until the jack is available at the Job1 job site. Calculation of the availability of the jack for Job1 at the job site of Job1 would need to be aware of when the task of Job2 relinquishes use of the jack, and would also need to be aware of the duration of time to move the jack from the work site of Job2 to the work site of Job1. Since the task “change the brake pads” of Job1 requires a jack, that task cannot start until the jack is available. If there is a delay in acquiring and positioning the jack for Job1, then the task “change the brake pads” would be delayed. Further, if other tasks of Job1 cannot start until the task “change the brake pads” has been completed, those tasks cannot start. In some cases the unavailability or delayed availability of a resource has a ripple effect that negatively affects the overall project schedule (e.g., makes the project take longer), and or may miss particular milestones.

In some cases a ripple effect can be very significant. Certain task groupings can imposes explicit or implied constraints that must be respected in execution of the tasks of a project. For example, consider an explicit constraint in the form: all “teardown asset X” tasks must be completed before any “inspect asset X” tasks can occur. Such groupings can precipitate milestones which can occur serially or can occur in parallel. Milestones can have their own “earliest date” and/or “target completion date” and/or even “minimum duration” for consideration during construction and execution of the project plan. Milestones and their constituent tasks can potentially impact the critical path, and it follows that the timeliness of the availability of resources that are assigned to tasks that need to be completed prior to achievement of milestones, where the timeliness of the achievement of milestones can potentially impact the critical path.

The herein-disclosed project scheduling system can calculate a project schedule while considering resource availability and risk-awareness as constraints. The aforementioned system can identify tasks that have resource demands, and further, such a system is able to schedule availability and positioning of the demanded resources such that the resources are available for the start of the corresponding tasks.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### DESCRIPTIONS OF EXEMPLARY EMBODIMENTS

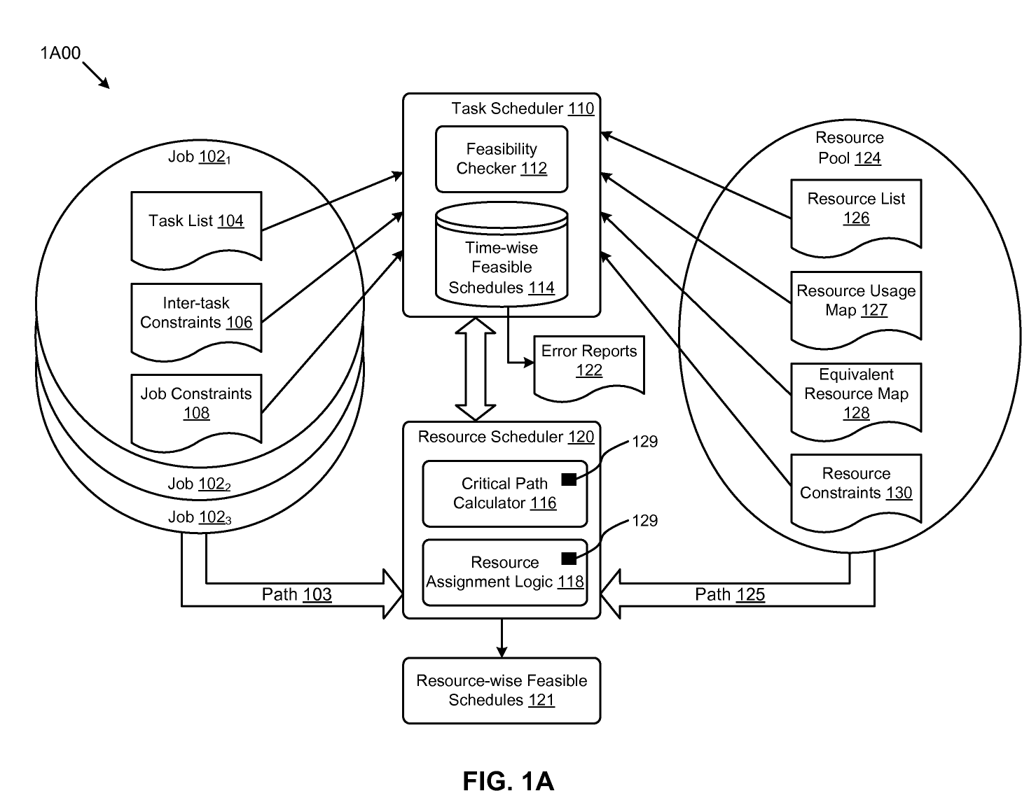

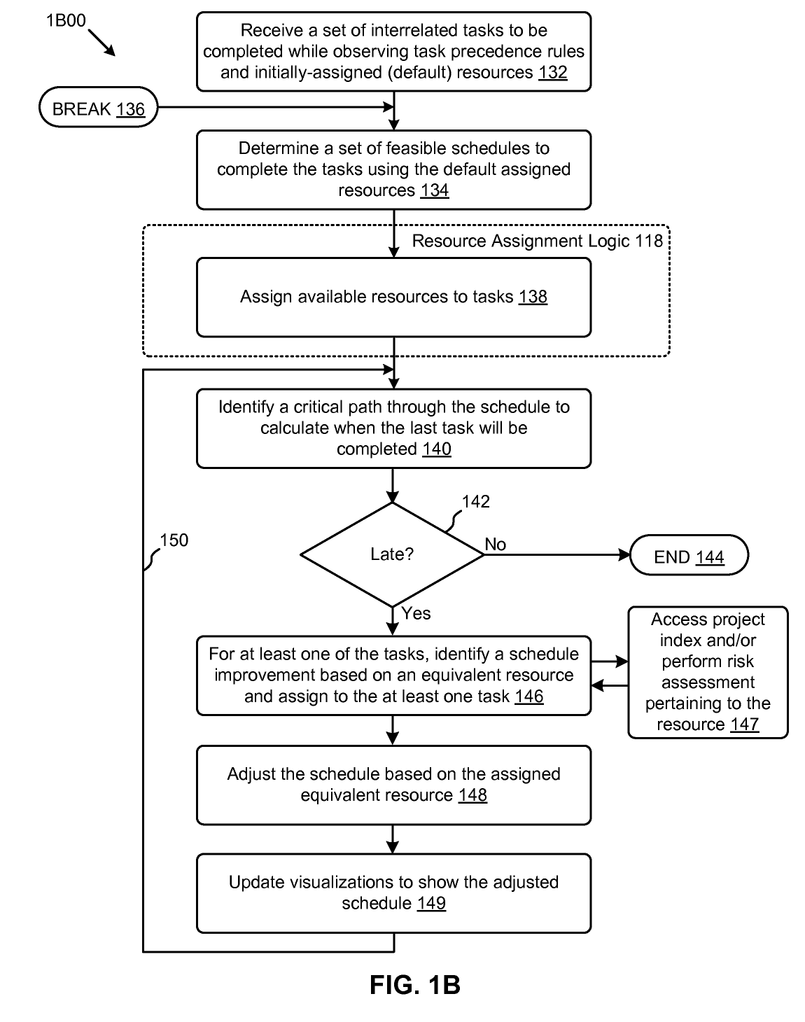

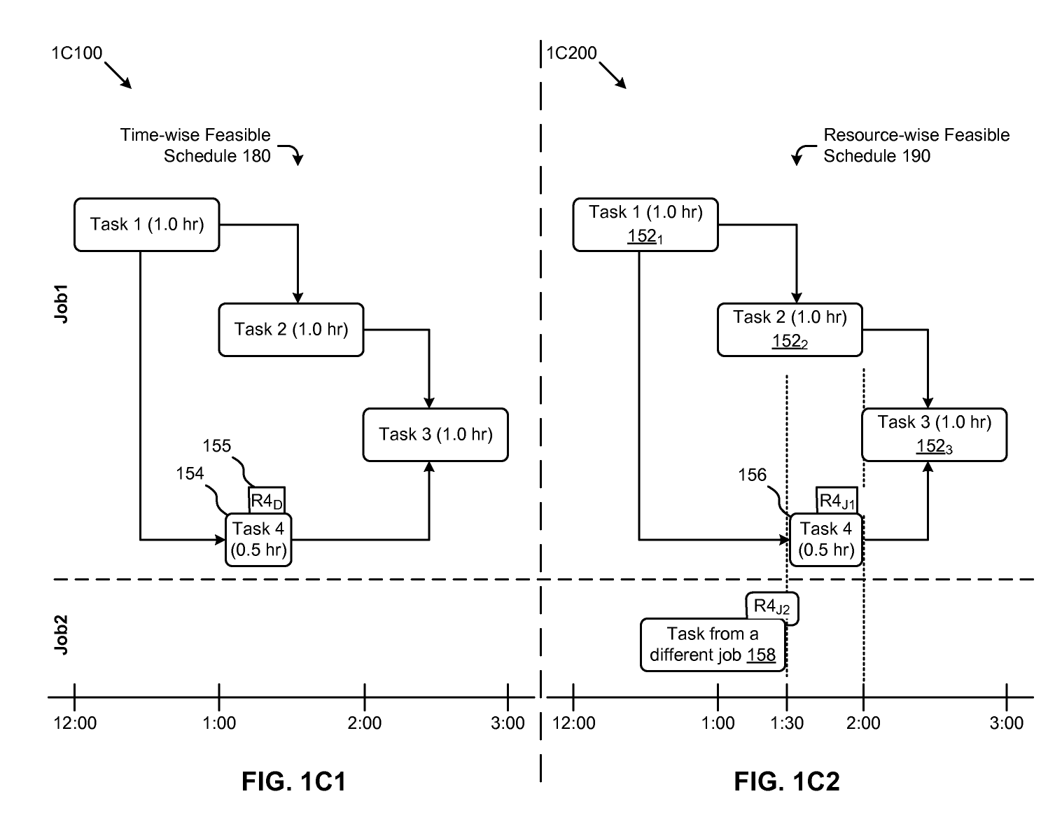

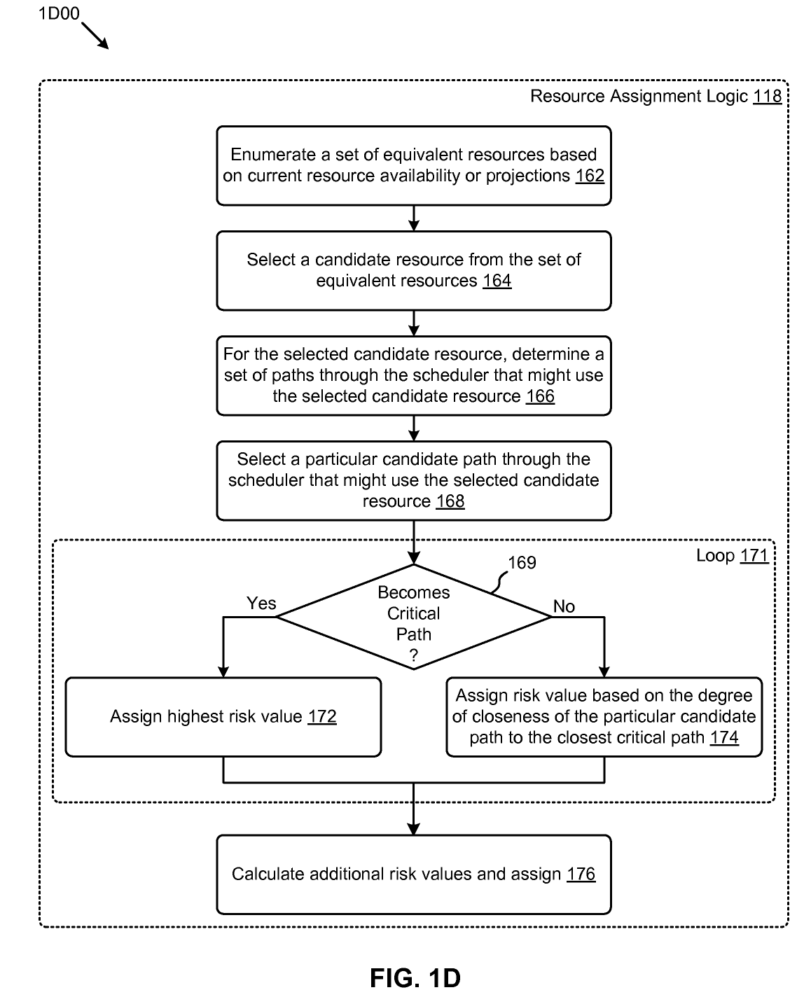

FIG. 1A depicts an environment 1A00 for implementing reducing critical paths using risk-aware project scheduling techniques. As an option, one or more instances of any of the systems of environment 1A00 or any aspect thereof may be implemented in any context.

As shown in FIG. 1A, a task scheduler 110 receives inputs in the form of jobs (e.g., (job1 102₁, job1 102₂, job1 102₃, etc.) and inputs that pertain to a resource pool 124. A particular job comprises a list of tasks constituent to the job. A task list 104 is accompanied by inter-task constraints 106. Such inter-task constraints can describe start and finish relationships between tasks. For example a particular task “Task2” might not be able to start until another task “Task1” has completed. This is an example of a “starts after end” or “finish-to-start” constraint. Other inter-task constrains are possible, some of which are shown in the listing in the following paragraph, and some of which are shown and discussed as pertains to the appended figures.

Inter-task constraints can be modeled at small time granularities (e.g., hour, minute, second, etc.). Some examples of inter-task constraints include:
Starts after End
Starts after End with Min Separation
Starts after End with Max Separation
Starts after End with Min and Max Separation
Starts At End Start immediately after previous task has ended
Starts after Start
Starts after Start with Min Separation
Starts after Start with Max Separation
Starts after Start with Min and Max Separation
Starts At Start
Ends At End

In addition to task constraints, a job description may comprise any number of job constraints 108. Strictly as an example, a job constraint can specify a target date or deadline date for completion of the job. As another example, a job constraint can specify an earliest start date for a job or a group of jobs, and/or an “earliest date” constraint can be imposed on a task or job. The task scheduler 110 can arrange a schedule for a single job, or task scheduler 110 can arrange a schedule for any number of jobs. In exemplary cases, the task scheduler constructs many possible schedules for the tasks given in a task list while observing inter-task constraints. Even though a particular candidate schedule can be constructed such that all of the tasks honor all of the pertinent time-wise inter-task constraints, the constructed schedule may not be optimal, or unique, or may not even be feasible with respect to other constraints. Accordingly, a feasibility checker 112 is provided, and constructed candidate schedules can be checked for feasibility before being added to a repository of time-wise feasible schedules 114. It is possible that there are no time-wise feasible schedules (e.g., task1 cannot begin until task2 finishes, and task2 cannot begin until task1 finishes), so a facility for error reports 122 is also provided.

In addition to job-related and/or task-related inputs provided to task scheduler 110, resource pool inputs are also provided. As shown, the resource pool 124 comprises a resource list 126, an equivalent resource map 128, and a set of resource constraints 130. A resource pool 124 can also model resource availability, and many variations as to resource availability are possible. For example, if a resource is available for a particular shift (e.g., 7 am-3 pm) only during weekdays, then this availability can be considered as a resource constraint. If a resource is deemed to be unavailable during certain periods (e.g., periodic rest breaks and/or meal breaks), a resource pool 124 can model this as a constraint. Further, the consideration of the type of break can be associated to a resource based on a resource type. A break can be characterized as a “delay” period or as a “down” period, and the characterization may be included in risk assessments. A delay period and/or a down period can carry certain ruled. As illustrative examples:
A “delay break” can be associated with a scheduling rule such as, “A one hour task can start 15 min before the break, pause, and continue the remaining 45 minutes after the break.”
A “down break” can be associated with a scheduling rule such as: “A down break must be scheduled to occur contiguously. Or, a scheduled down break cannot cause interruption of any tasks.”

Strictly as further illustrative examples, a resource list can comprise equipment (e.g., construction vehicles, machines, test equipment, repair equipment, etc.) and/or tools (e.g., a screwdriver) and/or materials (e.g., quarts of oil) and/or personnel. A given resource can be characterized by count and/or ID and/or quantity. For example, resource pool contents can include a piece of equipment known as a “jack”. The pool can contain some number of units of the jack (e.g., three units) identified by ID (e.g., Jack#1, Jack#2, Jack#3, etc.). Some resources in the resource pool are characterized using a quantity (e.g., 40 quarts of oil), and some resources in the resource pool are characterized by a particular quality or skill or other property (e.g., a laborer certified for maintenance work on Boeing 737 aircraft engines). The equivalent resource map 128 codifies resource alternatives. For example, a “mid-size jack” can be used as an alternative to a “small jack”, even though a “small jack” cannot be used as an alternative when a “mid-size” jack is demanded. Similarly, a “certified contractor” can be used as an alternative to a “certified employee”. Such a mapping of equivalents or alternatives can be codified in an equivalent resource map 128.

Further, a particular resource in a resource pool might have associated resource constraints 130. Strictly as examples, use of a particular piece of equipment might carry the constraint that the particular piece of equipment needs to be prepositioned at a given job site one day before use, and/or the particular piece of equipment needs to be serviced at the job site before use at the job site. Or, a resource in the form of material might carry an all-or-none constraint such as oil (e.g., if a task “change the crankcase oil” requires 10 quarts of oil, the task cannot be started until all 10 quarts of oil are available to the task). Still further, in addition to risk assessment of a particular resource (e.g., a certified contractor versus a certified employee), many varied and complex resource alternatives can be evaluated. For example, a task might demand a “certified contractor” plus a tool such as a “manual jack”. However if a “certified employee” is resourced, the “certified employee” can be defined to accomplish the task using either a “manual jack” or an “automated jack” (e.g., based on codified knowledge of the appropriate employee training to use the “automated jack”). Scheduling might be further complicated by the need for concurrent use of more than one resource (e.g., “a two-person task”). Concurrency must be considered since each resource (e.g., a person) might be on different work-shift schedules. Strictly as one possible technique, replacement groups can be defined and used in determining a schedule. A replacement group and/or any component of a replacement can carry its own risk value.

During the course of determining the tasks to be accomplished in order to complete a job, the project manager might associate a demand for any one or more resources to a particular task. The task scheduler might construct schedules including a default assignment of resources from the resource list 126. Such a default assignment might be without regard to the resource availability to the task. As such the task scheduler 110 constructs time-wise feasible schedules even though the particular scheduling and/or ordering and/or availability of the resource has not been addressed.

As shown, the environment 1A00 includes a resource scheduler 120. The resource scheduler in turn includes one or more instances of resource assignment logic 118 and a critical path calculator 116. The resource scheduler 120 receives time-wise feasible schedules, job information (see path 103), and resource pool information (see path 125). Using the resource assignment logic, the resource scheduler 120 can output resource-wise feasible schedules 121. In some cases the resource scheduler 120 can output resource-wise feasible schedules 121 using only the aforementioned default resource assignments. In other cases, the initially-defined or default resource assignments might violate one or more constraints. For example, if a task for Job1 demands a “small jack” and even though the default resource assignment (e.g., from the resource list) included a “small jack”, it might be determined that the needed resource was already in use on another job (e.g., another job in the same project, or another job in a different project), and thus unavailable for the task of Job1. In such cases, resource assignment logic 118 can be employed. Strictly as one example, resource assignment logic 118 might perform as follows:
Determine the specific nature of the unavailability (e.g., resource is down for repair, resource is at another job site, resource is back-ordered, etc.).
Access the equivalent resource map 128 to identify an alternative or equivalent resource, and assign the alternative if available, or proceed with additional processing.
Access the resource usage map 127 to identify a soon-to-be-available demanded resource or equivalent alternative. In this and certain other cases, data from other jobs and/or data from the resource usage map 127 can be accessed to determine a schedule for availability of the demanded resource or equivalent.

As still further examples, resource assignment logic 118 takes into account any combinations of resource assignment or reassignment risk (e.g., intrinsic resource availability risk, risk of the task or path becoming longer), project priorities, and/or task priorities. The act of taking the aforementioned in to account serves to make the appropriate resource assignment decisions so as to result in a project schedule that manages critical paths while minimizing risk.

At one moment in time, the processing of resource assignment logic 118 can determine a resource-wise feasible schedule based on a soon-to-be-available demanded resource or equivalent alternative. However, it is possible that at a next moment in time, the task corresponding to the soon-to-be-available demanded resource runs into a delay, thus making the soon-to-be-available demanded resource available in a correspondingly delayed timeframe. Accordingly, a project manager would want to see an up-to-date (e.g., daily, hourly, to the minute, to the second, etc.) project schedule on demand. Moreover, a project manager would want to see an up-to-date (e.g., daily, hourly, etc.) project schedule that has been adjusted (e.g., via assignment of equivalent resources) so as to be completed on schedule (e.g., as per the job constraints 108). Accordingly, exemplary systems provide processing for dynamically adjusting a project schedule.

In some cases the resource scheduler 120 and constituent or other operational units (e.g., critical path calculator 116 and/or resource assignment logic 118) can take aggressive remedial action pertaining to tasks that are not strictly on the critical path, but have a small amount of lead time. One possible technique employs a quantification of risk in the form of a project risk index 129, and the project risk index 129 can be embodied as a value held in and/or accessible by the resource scheduler 120.

FIG. 1B is a flowchart 1B00 for dynamically adjusting a project schedule in accordance with techniques for reducing critical paths using risk-aware project scheduling techniques. As an option, one or more instances of flowchart 1B00 or any aspect thereof may be implemented in the context of the architecture and functionality of the embodiments described herein. Also, the flowchart 1B00 or any aspect thereof may be implemented in any desired environment.

The processing steps and decisions as shown in FIG. 1B are purely exemplary, and their appearance in a particular order is purely illustrative. Any of the steps and/or decisions of FIG. 1B can be performed in any order as may be implemented in any system for reducing critical paths using risk-aware project scheduling techniques.

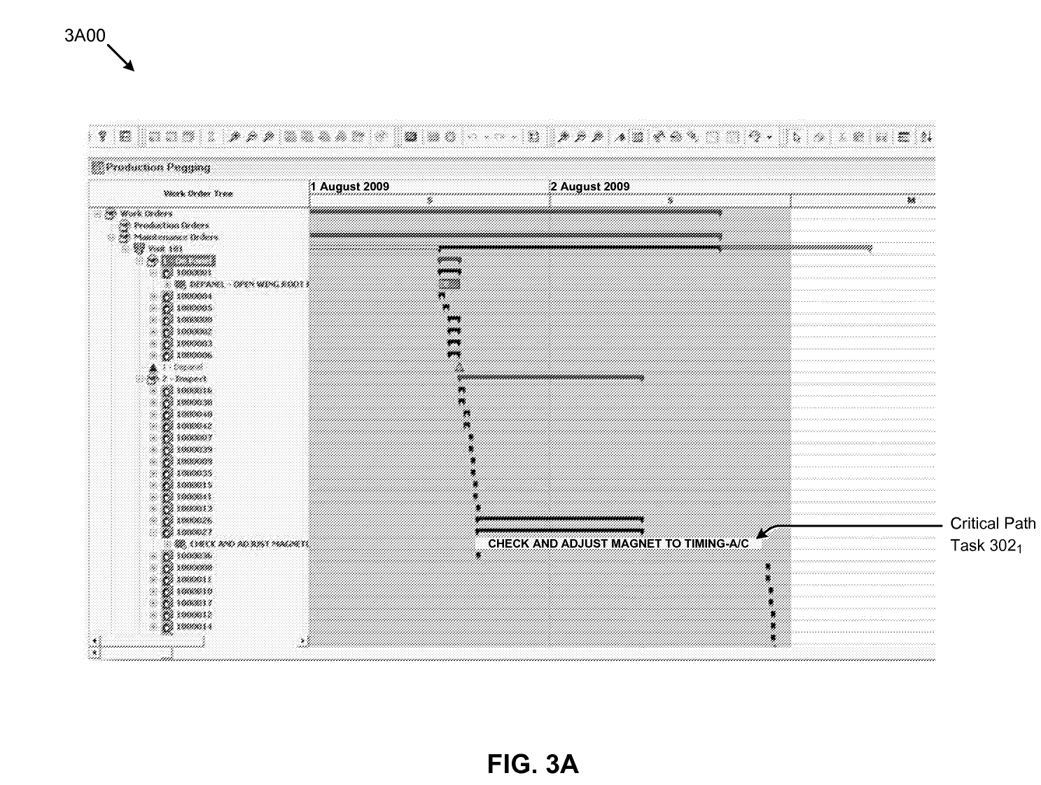

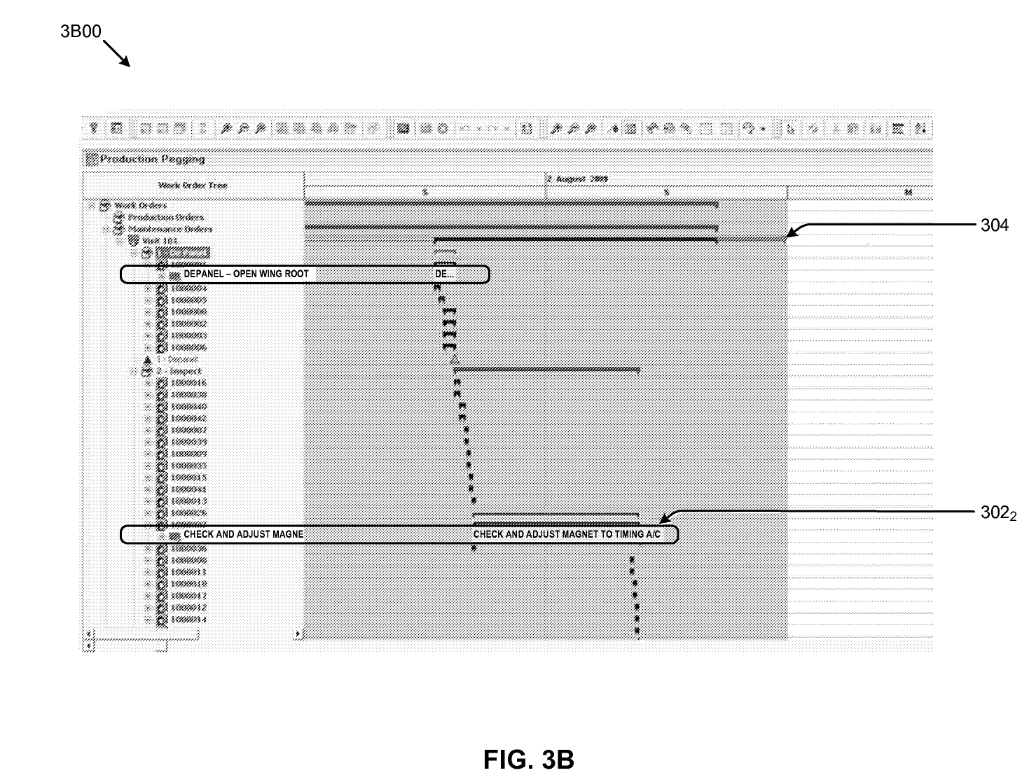

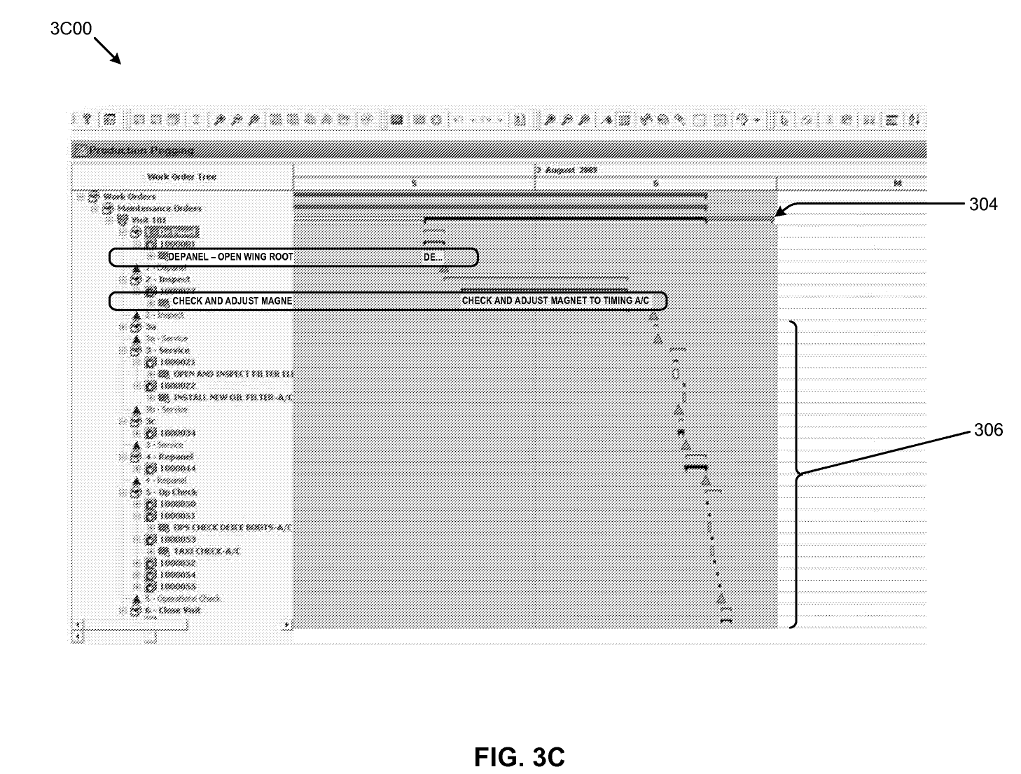

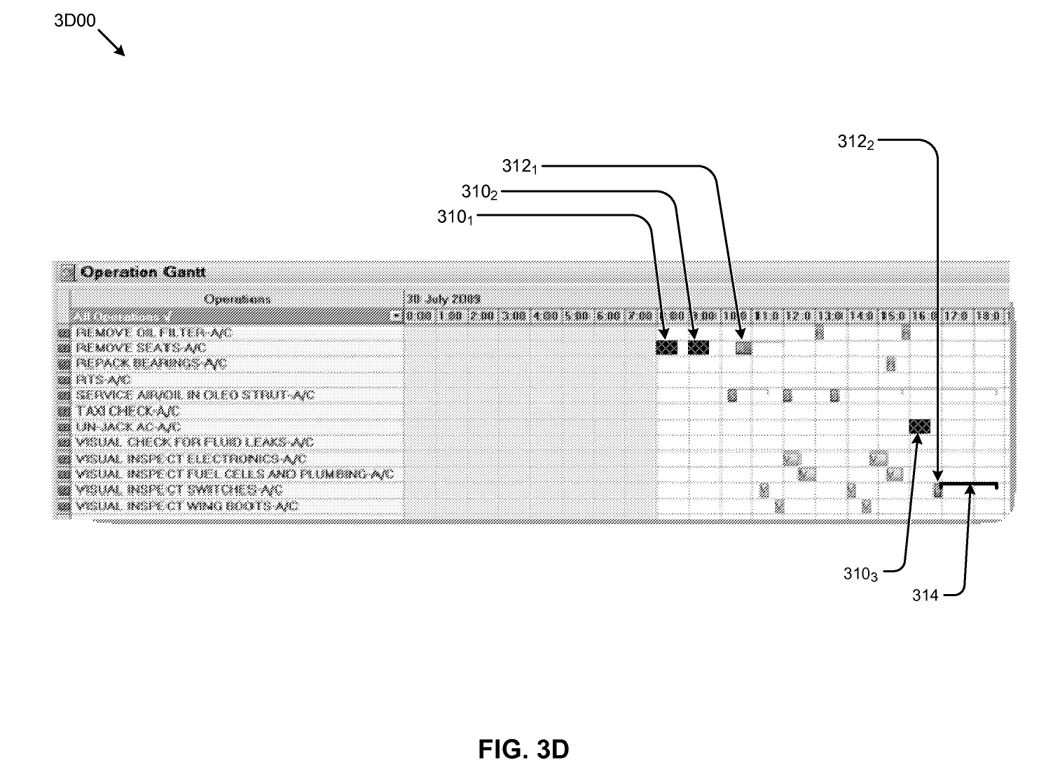

As shown, the flow commences by receiving a set of tasks to be completed while observing time-wise constraints and initially-assigned resources (e.g., see step 132). A set of time-wise feasible schedules are generated (see step 134). Such a schedule can be visualized (e.g., see FIG. 3A). A candidate time-wise feasible schedule is selected, and a process (e.g., resource assignment logic 118) assigns resources to the tasks of the selected schedule based on the then-current resource availability or projection of availability (see operation 138). As was heretofore described, even though a particular candidate schedule might be time-wise feasible, it might include resource demands that cannot be satisfied on the given time-wise feasible candidate schedule. In particular, processing within a resource scheduler (e.g., within a critical path calculator 116) might identify a critical path through the candidate schedule (see operation 140), and might report that the last task will be completed later than the intended deadline for the job (see decision 142). Such situations can be identified and visualized (see FIG. 3B).

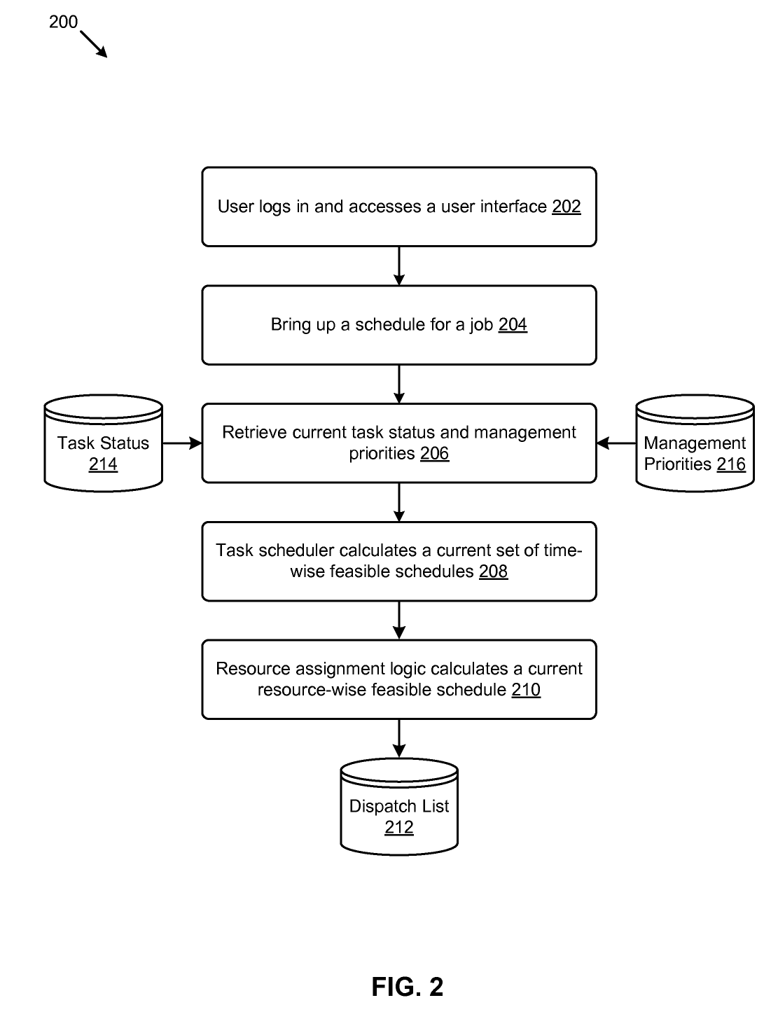

Merely knowing that a job is expected to be late may not be acceptable to the project management team. Accordingly, remedial action should be taken. As shown in FIG. 2, if, after assigning resources to the tasks based on the then-current resource availability or projection, the job is expected to finish late, then the resource management logic (e.g., resource assignment logic 118) might be invoked to perform remedial actions (see decision 142).

Visualizations (e.g., as depicted in FIG. 3B) serve to aid the project manager to determine “why” the job is expected to finish late (e.g., by showing critical path tasks that can be remediated to reduce the job completion timeframe). Further, some embodiments are configured to identify one or more equivalent resources, corresponding to critical path tasks, to assign the identified equivalent resources to the critical path task and to adjust the overall schedule based on the remediation. For example, a step 146 serves to identify a schedule improvement based on an earlier-available equivalent resource, assess risk associated with the earlier-available equivalent resource (see step 147), and assign the earlier-available equivalent resource to the critical path task. Then, the overall schedule can be adjusted based on the effect of assigning the earlier-available equivalent resource (see step 148). In the event that paths of the project are being displayed during schedule improvements, a new critical path (or paths) might cause visualizations to visibly reflect the change (see step 149). In some cases there is no equivalent or other suitable resource that results in a schedule improvement. One approach to addressing that possibility is to break out of the loop (see path 150) and continue processing by identifying another critical path (see break 136). Such processing can be iterated (see path 150) until the overall schedule is not late, in which case the decision 142 will cause the iterations of flow 1B00 to end (see end 144).

In some cases, identification and prepositioning of earlier available equivalent resources to assign to a critical path task can include an expedited inventory replenishment event. For example, if the task “change the oil” includes a demand for “four quarts of oil”, but only one quart of oil was shown to be available in the resource pool by the start of the task, then an inventory replenishment event for at least three quarts of oil can be raised, possibly with an expedited delivery request, so as to preposition the oil before the scheduled start time of the task “change the oil”.

Raising an expedited inventory replenishment event is merely one way to address a critical path. In other cases, a demanded resource can be sourced from another job. The following figures introduce several techniques for remediating tasks on the critical path.

FIG. 1C1 is a diagram 1C100 showing a time-wise feasible schedule as used in systems that implement reducing critical paths using risk-aware project scheduling techniques.

FIG. 1C2 is a diagram showing a resource-wise feasible schedule 190 as used in systems that implement reducing critical paths using risk-aware project scheduling techniques, according to some embodiments.

As shown in FIG. 1C1 and also in FIG. 1C2, Task1 proceeds to Task2, which proceeds to Task3. Also, Task1 proceeds to Task4, which proceeds to Task3. When Task3 completes, the job completes.

For illustrative purposes, the diagrams show only a few tasks and a few inter-task dependencies, however within a job or work order, there can be many tasks which, in turn, have specific respective inter-task dependencies. Such inter-task dependencies can include:
Start a next task any time after its predecessor task is complete.
Start the next task immediately after a predecessor task is complete.
Start the next task any time after a predecessor task starts (e.g., parallel progression of tasks).
Start the next task immediately at the same time as a predecessor task starts (e.g., for concurrent starts).
End the next task as soon as a predecessor task ends (e.g., for concurrent ends).
Start the next task after the first task is complete and start the next task no sooner than a specific time (e.g., for after a cure time, or after a settling time, etc.).
Start the next task after the first task is complete and start the task no later than a specific time (e.g., for before a cure time ends, or before a settling time ends, etc.).

In exemplary cases the critical path calculation is performed using a forward/backward temporal propagation approach, which implements forward and backward temporal propagation at the same time. The forward and backward temporal propagation calculation will compute “earliest start time” (EST) and “latest end time” (LET) for each task in a job. After performing forward and backward temporal propagation calculations, the scheduled start time (ST) and end time (ET) are known for each task, and slack times can be calculated. In some embodiments, the following definitions are used:
Head slack=ST−EST;
Tail slack=LET−ET; and
Slack=head slack+tail slack.

The critical paths can be identified by identifying all tasks with slack time equal to zero. Any delay of start or completion of tasks on the critical path will result in the delay of the completion of the job.

To illustrate, and as shown, consider the diagram 1C100 where the schedule shows Task1, Task2, and Task3 all requiring one hour each. Also shown is Task4 154 that requires 0.5 of an hour for processing. The inter-task constraints for Task4 require that this Task4 can start only after Task1 has completed. In addition, Task3 can begin only after Task4 has completed its processing.

The time-wise feasible schedule 180 includes a critical path Task1→Task2→Task3:
Task1 starts at 12:00 and ends at 1:00 (with zero slack time).
Task2 starts at 1:00 and ends at 2:00 (with zero slack time).
Task3 starts at 2:00 and ends at 3:00 (with zero slack time).

The shown Task4 is not on the critical path of this time-wise feasible schedule. Task4 can begin as early as 1:00 (after its predecessor Task1 completes) and can end as late as 2:00 (ending when Task3 is scheduled to begin). This schedule assumes that the resource demands of Task4 can be satisfied. If the assumption is true, then Task 3 can complete by 3:00. At any moment in time, the assumption may be true, or may soon become true, or may not be true, or may soon become not true. If the resource demanded by Task4 (e.g., R4 demand 155) is not available for at least 0.5 hours during the time 1:00 to 2:00, then the projected completion time of 3:00 cannot be achieved.

During logic processing such as resource assignment logic 118, it might be determined that the resource corresponding to the R4 demand 155 is not available, but would become available at 1:30, which is as soon as usage by another job (e.g., Job2) relinquishes the resource (e.g., at completion of the shown task from a different job 158). In such a situation, and as shown in diagram 1C200, the time-wise feasible schedule 180 is transformed into the resource-wise feasible schedule 190, including the adjusted resource demands of adjusted Task4 156. There may be multiple possible resource-wise feasible schedules, and one or another of the individual ones of the multiple possible resource-wise feasible schedules might be assessed for its risk(s) and a particular risk-assessed resource-wise feasible schedules might be selected for further processing. Various techniques for evaluating risks of resource assignments and the impact of the risk to more critical paths is now briefly discussed.

FIG. 1D is a flowchart for evaluating risks 1D00 of resource assignments as used in systems for reducing critical paths using risk-aware project scheduling techniques, according to some embodiments.

Some resource assignments carry more risk than other resource assignments. For example, consider two resources of the same type, ResourceA and ResourceB, either of which could be assigned to a particular subject task. Further consider that it can be known (e.g., from maintenance records) that ResourceA has 50% more downtime hours than does ResourceB. It follows that ResourceA has more risk (e.g., of going down) than does ResourceB. Given the choice of the two resource candidates (e.g., ResourceA and ResourceB) the disclosed risk-aware scheduler would preferentially select ResourceB so as to avoid introducing the risk of ResourceA into the subject task.

As another example, consider two resources of the same type, for example, ResourceA and ResourceB, either of which could be assigned to a particular subject task. Further consider that it can be known (e.g., from maintenance records) that ResourceA would require transportation from its current location in order to position ResourceA at the work location for the subject task to begin on time, whereas ResourceB is already positioned at the work location for the subject task. It follows that ResourceA has more risk (e.g., due to the transportation involved) than does ResourceB. Given the choice of the two resource candidates (e.g., ResourceA and ResourceB) the disclosed risk-aware scheduler would preferentially select ResourceB so as to avoid introducing the risk of transporting ResourceA into the subject task work site.

As another example, consider two non-critical paths through a project, one of the two non-critical paths being longer than the other. Further consider that both non-critical paths through a project demand a resource of the type ResourceA and ResourceB. And still further consider that ResourceA performs half as fast as ResourceB. Given the choice of the two resource candidates (e.g., ResourceA and ResourceB) to assign to the two non-critical paths, the disclosed risk-aware scheduler would preferentially select ResourceB to assign to the longer path, and would select ResourceA to assign to the shorter path.

Following the operations within the flowchart for evaluating risks 1D00 or variations thereto, the aforementioned risk-assessed preferential resource assignment can be made. Other risk mitigating techniques are also disclosed in FIG. 1D. As shown, resource assignment logic 118 entered and the flow evaluates a given feasible schedule (see step 134 of FIG. 1B) and a set of candidate equivalent resources is formed (step 162). At least some of the candidate equivalent resources are selected (step 164) and considered as a possibility to assign to a task or tasks within the paths of the given feasible schedule (step 166). Then, a particular path that might use the selected candidate resource is evaluated with respect to the effect that the assignment of the candidate equivalent resource might have on the particular path (see step 168), and a loop is entered (see loop 171). If the path then becomes a critical path of the schedule (see decision 169) then a high risk value is assigned (see step 172). Otherwise, a risk value is assigned based on the evaluation or likelihood that that particular assignment to that particular path might extend that path in time. In some cases the path is indeed extended, and may be extended to the point that it approaches the timing of a critical path. A risk assessment is made (e.g., by determining the extent or likelihood that it approaches the timing of a critical path) and a risk value is assigned as pertaining to the assignment of the resource to the particular path (step 174).

In some embodiments, other risk assessments can be made (step 176), and the resource assignment logic 118 returns a set of paths paired with a corresponding risk value. In some cases, management priorities is modeled as a risk value, and when risk assessments are made (e.g., in step 176), management priorities associated with the task (if any) or management priorities associated with the path (if any) are considered in the risk assessment of FIG. 1D.

The aforementioned description includes techniques to assess risk and to assign a resource to a task in time so as to avoid delaying project completion Further techniques can produce resource-wise feasible schedules that reduce the critical path and bring in the job completion time or date. Some of such techniques are shown and described as pertaining to FIG. 2.

FIG. 2 is a use model diagram 200 showing interactive uses of resource assignment logic as used in a system that implements reducing critical paths using risk-aware project scheduling techniques. As an option, one or more instances of use model diagram 200 or any aspect thereof may be implemented in the context of the architecture and functionality of the embodiments described herein. Also, the use model diagram 200 or any aspect thereof may be implemented in any desired environment.

The use model commences when a user logs in and accesses a user interface (see step 202). The user selects a job or a set of jobs, or a handle that includes a job or a set of jobs (see step 204), and the schedule or schedules and any constituent task status and management priorities etc. are retrieved (see step 206). The current status (e.g., task status 214) is retrieved for all tasks and applied to the corresponding schedules. Also priorities (e.g., management priorities 216) are retrieved and applied, and some of the aforementioned are processed for display (see FIG. 3A through FIG. 3D).

Management priorities can be associated with a project or a job or a task. In some cases more than one task can demand a particular resource for which there is a limited supply of such demanded resources. These possibilities introduce situations where multiple requestors compete for a resource. Some embodiments implement a regime where the higher priority task or project will be assigned resources first (e.g., all other things being equal). A regime for applying priorities and/or for calculating risk can include any of the following rules:
Project Request Date (e.g., assign resources to the earlier requester).
Project Priority (e.g., assign resources based on an explicitly assigned or inherited project priority).
Work Order Date (e.g., assign resources based on an explicitly assigned or inherited work order date).
Work Order Priority (e.g., assign resources based on an explicitly assigned or inherited work request priority)

A hierarchy for the calculation of risk using tie breaking rules can be codified as follows:
To break a tie, the project with the earliest request date gets priority.
To break a tie, (e.g., when request dates are the same), the project with highest priority wins.
To break a tie, if the request date and priority are the same, then task level priorities are used.
To break a tie, if the request date and priority are the same, and task level priorities are the same, then task level request dates are used.

Continuing the discussion of task scheduling, a task scheduler (e.g., task scheduler 110) can perform or re-perform calculations to produce an updated set of timewise-feasible schedules (see step 208 and see FIG. 3A). An embodiment of resource assignment logic calculates a set of resource-feasible schedules (see step 210 and FIG. 3B). A dispatch list is generated (see step 212).

In this use model, a project manager can determine if a job can be completed on time. In some cases the project manager can work with displayed representations of candidate schedules, and in some cases the project manager can indicate that remedial action should be taken. In some embodiments of the disclosure, the resource scheduler 120 or other operational unit can take remedial action as follows:
Identify an earlier-available resource corresponding to a demand from a task on a critical path. For example, secure a resource from a different job.
Change the availability of a needed human resources by adding authorized overtime hours and/or by adding more human resources of the same or equivalent availability and/or substitute alternative human resources.
Resequence tasks and/or activities so as to position one or more demanded resources in time for the resequenced tasks and/or activities.
Delay tasks (e.g., modify the earliest start date/time of one or more tasks to indicate a start time later than expected availability of the needed resource).
Expedite resources (e.g., expedited positioning of needed materials to occur in an earlier timeframe).

### Reducing Project Using Risk-Aware Project Scheduling Techniques

In some cases the resource scheduler 120 or other operational unit can take aggressive remedial action pertaining to tasks that are not strictly on the critical path, but have a small amount of lead-time. One possible technique employs a quantification of risk in the form of a project risk index 129. The value of a project risk index variable indicates the amount of risk for a project. A value of a project risk index variable can be a relative value used to compare the risk ascribed to one project as compared to the risk ascribed to another project. Or, a value of a project risk index variable can be an absolute value used to compare the risk ascribed to one project as compared to an absolute scale. In some embodiments, a project risk index variable correlates to the amount of work remaining to complete the project. Projects that are scheduled to complete sooner have less inherent uncertainty and risk in their schedules as compared to projects that have long completion horizons, which have more inherent uncertainty and risk in their schedules. In other embodiments, a project risk index variable correlates to the variance between a planned project completion date and actual performance (e.g., variance) to date. In other embodiments, an assessment of risk is made by calculating the slack time between a candidate adjusted critical path (e.g., using an alternative resource) and the critical path of the received subject project schedule to form a risky path value pertaining to a time-wise risk of the path, which is in turn used in an overall risk assessment.

### Critical Path Visualization

FIG. 3A is a screen display 3A00 of a project schedule visualization as used in systems for reducing critical paths using risk-aware project scheduling techniques. As an option, one or more instances of screen display 3A00 or any aspect thereof may be implemented in the context of the architecture and functionality of the embodiments described herein. Also, the screen display 3A00 or any aspect thereof may be implemented in any desired environment.

A user might want to identify critical paths in a schedule. Some embodiments provide visualizations of calculated critical paths that are visually presented as being distinguished from non-critical paths. One reason for providing critical path visualization is to improve human comprehension. For example, critical path visualization facilitates a user to quickly identify tasks that affect the overall schedule. Another reason is that an effective visualization reduces the number of manual display and manipulations of iterations.

As shown in FIG. 3A, a critical path task 302₁ spans a portion of Aug. 1, 2009 and almost the entirety of Aug. 2, 2009. Some jobs can have a very high number of individual unique tasks with many dependent relationships between the individual tasks. As shown, the bottom seven tasks (depicted just below critical path task 302₁) are scheduled to commence upon completion of critical path task 302₁. Those tasks and other tasks that are scheduled to commence upon completion of critical path task 302₁ could be started earlier if critical path task 302₁ were able to complete earlier. Application of certain of the techniques discussed herein can reduce the time for completion of critical path task 302₁, thus reducing the overall duration to completion for the job.

### Risky Path Visualization

In addition to visualizations of critical paths, some embodiments provide visualizations of paths that have a small slack time. Paths that have a small slack time may be an indication of risk for the respective tasks. Slipping a task having a small slack time might cause the task to become on the critical path and can affect the overall completion time of the job. Managing risky paths in addition to critical paths becomes increasingly important when a shared resource (e.g., a serially-sharable resource) is demanded by tasks progressing in the same or overlapping time periods over multiple jobs or projects. Further, raw materials and/or tools needed by multiple jobs can also present lead times and/or other constraints that can influence the start of a task, and thus can influence which tasks are on a critical or risky path.

The present embodiment provides an improved approach for performing critical path identification, for example, when a critical path is defined as a path where if a task on the path is delayed, then the entire job will be delayed. In addition, some embodiments provide for an improved approach to display results of the critical path calculation. Such an improved approach allows the system to display sequences of tasks that must be completed on schedule in order for the entire job to be completed on schedule.

To illustrate, consider the interfaces shown in FIG. 3A through FIG. 3C. FIG. 3A shows an overall maintenance schedule including the critical path (which critical path includes critical path task 302₁). In FIG. 3B, the critical path and the overall job schedule has been reduced (e.g., using one or more of the techniques disclosed herein). As shown in FIG. 3C, the interface can be configured to only show the critical paths (e.g., by removing non-critical paths from the display). A use model, including the progression from FIG. 3A through FIG. 3D, is further described below.

FIG. 3B is a screen display 3B00 of a project critical path visualization as used in systems for reducing critical paths using risk-aware project scheduling techniques. As an option, one or more instances of screen display 3B00 or any aspect thereof may be implemented in the context of the architecture and functionality of the embodiments described herein. Also, the screen display 3B00 or any aspect thereof may be implemented in any desired environment.

As shown in FIG. 3B, the last-to-finish critical path task 304 now finishes on August 2nd rather than on August 3rd. This is because the critical path task 302₂ has been reduced by using the herein-disclosed techniques.

FIG. 3C is a screen display 3C00 of an isolated critical path visualization as used in systems for reducing critical paths using risk-aware project scheduling techniques. As an option, one or more instances of screen display 3C00 or any aspect thereof may be implemented in the context of the architecture and functionality of the embodiments described herein. Also, the screen display 3C00 or any aspect thereof may be implemented in any desired environment.

As shown in FIG. 3C, only the critical path tasks are shown. In this display, the additional tasks 306 that are scheduled to commence after task 302₂ completes are depicted. The job ends at the end of August 2. Further visualizations of tasks, associated risk, and slack time of tasks are presented in GANTT charts (named after Henry Gantt), such as the GANTT chart risky path visualization embodiment of the following FIG. 3D.

FIG. 3D is a screen display 3C00 of a GANTT chart risky path visualization as used in systems for reducing critical paths using risk-aware project scheduling techniques. As an option, one or more instances of screen display 3C00 or any aspect thereof may be implemented in the context of the architecture and functionality of the embodiments described herein. Also, the screen display 3C00 or any aspect thereof may be implemented in any desired environment.

As shown, the GANTT chart risky path visualization includes visualization of tasks that are on risky paths. In this embodiment, the highlighted rectangles (e.g., risk task 310₁, risk task 310₂, risk task 310₃) are tasks that are on a critical path. In other embodiments visualizations can use techniques other than highlighting (e.g., bolding, flashing, animations, bounding, etc.). Tasks that are not on a critical path (e.g., task 312₁, task 312₂) may include a visible slack line 314 that indicates how much the task can slip before it becomes on the critical path.

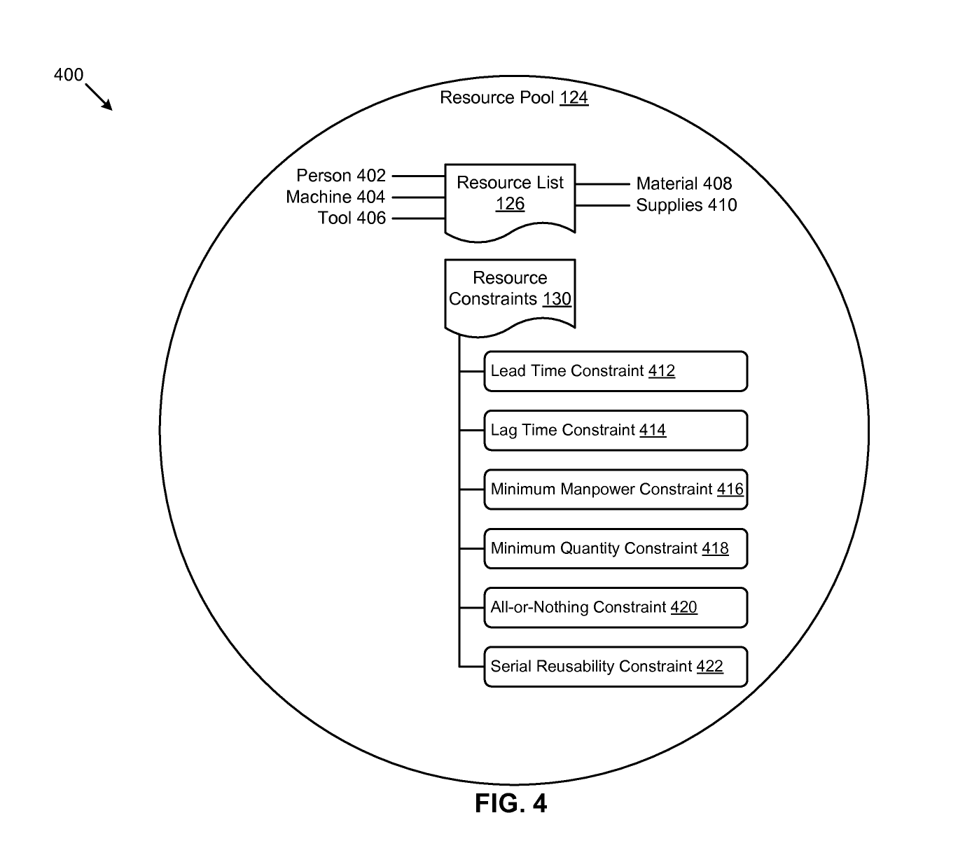

FIG. 4 is a diagram 400 of resource pool schema as used in systems for reducing critical paths using risk-aware project scheduling techniques. As an option, one or more instances of diagram 400 or any aspect thereof may be implemented in the context of the architecture and functionality of the embodiments described herein. Also, the diagram 400 or any aspect thereof may be implemented in any desired environment.

As shown in FIG. 4, a resource pool 124 comprises a resource list 126, which resource lists receives inputs that describe resources of a person 402, a machine 404, or a tool 406, and various forms of materiel 408 and supplies 410.

In addition to the aforementioned resource list, a resource pool 124 can comprise resource constraints 130, which in turn comprises constraints in the form of a lead-time constraint 412, a lag-time constraint 414, a minimum manpower constraint 416, a minimum quantity constraint 418, an all-or-nothing constraint 420, and a serial reusability constraint 422.

Strictly as examples, such resource constraints can carry semantics as follows:
A lead-time constraint 412 refers to the amount of time needed to prepare a tool or piece of equipment (or other resource) prior to commencing use on a job. In some cases, the lead time is further extended by transportation time needed to (for example) move a piece of equipment from one job site to another job site.
A lag-time constraint 414 refers to the time needed to clean or refurbish or otherwise maintain a piece of equipment.
A minimum manpower constraint 416 refers to the number of human resources to accomplish a task. For example, it might require two people to change a tire: one person to change the tire, and another person to monitor the performance and/or to perform in a supervisory or safety officer function.
A minimum quantity constraint 418 refers to the minimum amount of a resource that is needed before a task can start. For example, if the task “change the oil” requires eight quarts of oil, then the task cannot start unless there are eight quarts on hand at the job/task site.
An all-or-nothing constraint 420, and
A serial reusability constraint 422 refer to the ability of a particular resource to be used on one job or task, and then to be used on successive different jobs/tasks. Only one job at a time can use a serially-reusable resource.

Resources can be grouped into resource replacement groups, and resource assignment logic 118 can apply resource replacement rules and/or observe resource replacement constraints. For example, a “small jack” and a “large jack” might be viable alternatives, and if so, they can be placed into the same resource replacement group. However, if rules are present such that a “junior mechanic” can use the “small jack” but only an “advanced mechanic” is qualified to use the “large jack”, then an alternate resource setwise pair can be defined. In this case the pair {“small jack”, “junior mechanic”} is defined to indicate a proper pairing. Also the pairs {“small jack”, “advanced mechanic”} and {“large jack”, “advanced mechanic”} are defined to indicate other proper pairings. Other pairings can be defined so as to support a variety of resource replacement rules and/or resource replacement constraints.

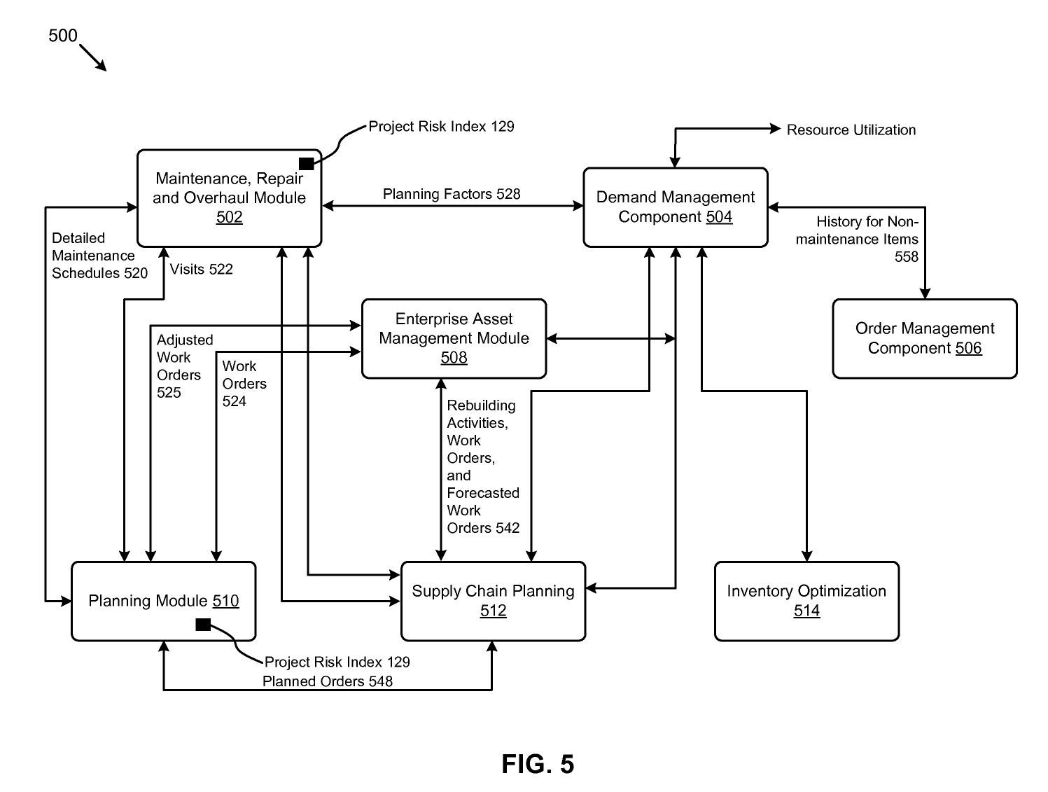

FIG. 5 is a diagram 500 of repair depot operations that exemplify techniques for reducing critical paths using risk-aware project scheduling techniques. As an option, one or more instances of diagram 500 or any aspect thereof may be implemented in the context of the architecture and functionality of the embodiments described herein. Also, the diagram 500 or any aspect thereof may be implemented in any desired environment.

There are many asset-intensive industries such as the oil and gas, construction, aerospace, and defense industries. These industries have complex and expensive assets that require a great deal of planning with regard to their proper upkeep and maintenance. For example, industries that have transportation assets may need to manage large fleets of vehicles and/or numerous pieces of equipment related to those vehicles, and may need to maintain repair depot facilities. Both scheduled and unscheduled downtime with these assets can have a significantly negative impact on operations including delays in schedules, lost efficiency, poor asset utilization, etc. Proper upkeep needs to be managed and maintenance needs to be scheduled in order to treat the assets in efficient ways.

The repair depot operations depicted in the shown embodiment includes a complex maintenance, repair and overhaul module 502 and/or an enterprise asset management module 508, which are integrated with an order management component 506 to perform the enterprise asset management. In turn, enterprise asset management module and the demand management component interfaces directly and/or indirectly with inventory optimization 514 and supply chain planning 512. The complex maintenance, repair and overhaul component and enterprise asset management functions provide historical and projection data as can be used for production planning, and for forecasting and supply chain planning 512.

The repair and overhaul module 502 communicates with a planning module 510, and such communication might include detailed maintenance schedules 520 and an accounting and/or forecast of repair depot events (e.g., visits 522). For example, a detailed maintenance schedule describes the conditions under which a particular maintenance operation is to be performed, such as after a certain date, or after some number of hours of operation. The planning module 510 can receive inputs from a supply chain planning function, and such inputs might include the contents and dates of planned orders 548. Further, the planning module 510 communicates with the enterprise asset management function to exchange work orders 524 and adjusted work orders. Work orders may be initially received by a planning module 510 from the enterprise asset management module 508, and can be considered by the planning module 510 as a project or job or task. After the planning module 510 schedules the work order(s), it may later adjust the project or job or task based on application of techniques for reducing critical paths using risk-aware project scheduling, and in doing so, the planning module 510 may emit an adjusted work order 525.

In one embodiment of this disclosure, historical materials usage, historical resource usage, and predictions for workload, operating tempo, and operating conditions of assets are sent to a demand management module. Such a system uses historical records (e.g., maintenance history and history for non-maintenance items 558) to calculate planning factors 528 that in turn are used to determine the statistical quantities of spare parts and hours of resource effort required to perform different kinds of maintenance activities. This data is used by various components of the system depicted in diagram 500.

### Improved Critical Path Scheduling

As earlier indicated, a project manager wants to understand (1) why a project is late, (2) how to pull in the completion date using available resources, and (3) how to do so while introducing only acceptable levels of risks associated with the assignment of the available resources. A project manager would avail himself of capabilities of a risk-aware, resource scheduling system that can identify the resource demands of various tasks, and then, for example, source alternate resources so as to reduce the critical path to project completion while concurrently managing risks associated with the assignments of the alternate resources.

Following herein-disclosed techniques, maintenance work order scheduling can be reduced as follows:
Reduce the critical path to project completion by observing lead-time constraints so as to identify a resource that can be prepared and positioned at a job site ahead of or on time for an earlier start of a task.
Reduce the critical path by resequencing activities, and/or by taking into account changeovers to increase the resource's availability.
Reduce the critical path to project completion by observing lag-time constraints so as to identify a resource that can be cleaned and maintained and/or otherwise prepared and positioned at a job site ahead of or on time for an earlier start of a task.
Reduce the critical path to project completion by observing a minimum manpower constraint and scheduling enough resources.
Reduce the critical path to project completion by adding manpower to a task when adding the manpower reduces the time to complete the task.
Reduce the critical path to project completion by pre-ordering materials so as to observe a minimum quantity constraint.
Reduce the critical path to project completion by observing serial reusability, and scheduling a task to begin when the resource becomes available for a second or subsequent use.
Reduce the critical path to project completion by identifying an alternative or equivalent resource so as to schedule a task to begin as soon as when the alternative or equivalent resource becomes available.

### Additional Embodiments of the Disclosure

### Additional Practical Application Examples

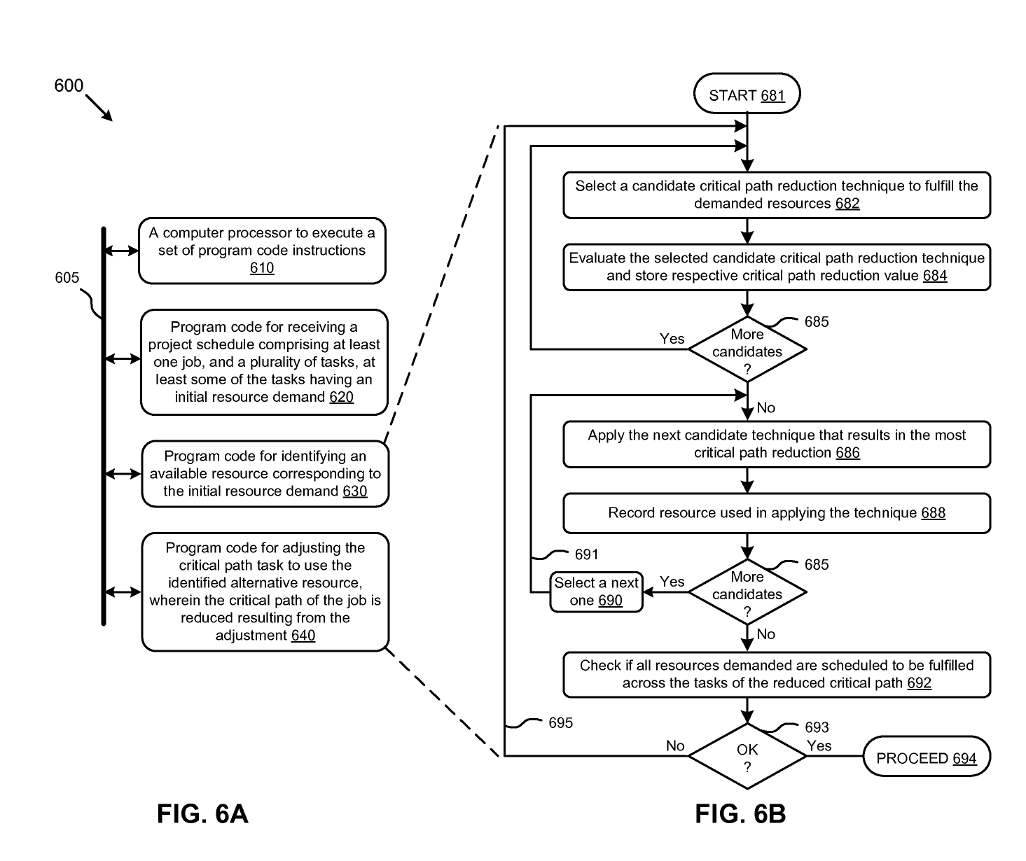

FIG. 6A is a block diagram of a system for reducing critical paths using risk-aware project scheduling techniques. As an option, the present system 600 may be implemented in the context of the architecture and functionality of the embodiments described herein. Of course, however, the system 600 or any operation therein may be carried out in any desired environment.

As shown, system 600 comprises at least one processor and at least one memory, the memory serving to store program instructions corresponding to the operations of the system. As shown, an operation can be implemented in whole or in part using program instructions accessible by a module. The modules are connected to a communication path 605, and any operation can communicate with other operations over communication path 605. The modules of the system can, individually or in combination, perform method operations within system 600. Any operations performed within system 600 may be performed in any order unless as may be specified in the claims.

The embodiment of FIG. 6 implements a portion of a computer system, shown as system 600, comprising a computer processor to execute a set of program code instructions (see module 610) and modules for accessing memory to hold program code instructions to perform: receiving a project schedule comprising at least one job, and a plurality of tasks, at least some of the tasks having an initial resource demand (see module 620); identifying an available resource corresponding to the initial resource demand (see module 630); and adjusting the critical path task to use the identified alternative resource, wherein the critical path of the job is reduced resulting from the adjustment (see module 640).

FIG. 6B is a flow diagram of a system 600 for reducing critical paths using risk-aware project scheduling techniques. As shown in the figures and described herein, there are many techniques to deal with resources of a project so as to reduce critical paths.

As shown, the flow of system 600 is entered having access to at least one critical path of a job having at least one task with a demanded resource (see start point 681). The flow proceeds to select a candidate critical path reduction technique to fulfill the demanded resources of the tasks on a critical path (see operation 682). The selected candidate critical path reduction technique is evaluated (e.g., with respect to a particular demanded resource) and the amount of reduction of the critical path (if any) is stored for later access (see operation 684). The aforementioned operations to select a candidate technique and evaluate the selected candidate technique is repeated over a plurality of candidate techniques until there are no more candidate techniques deemed to be selected and evaluated to calculate and store a possible critical path reduction value (see decision 685).

Having at least some possible critical path reduction values, the possible critical path reduction values are sorted (e.g., largest to smallest), and the selected technique that corresponds to the largest or larger critical path reduction values is applied (see operation 686). The application of the selected technique that corresponds to the largest or larger critical path reduction values may or may not result in any critical path reduction, however, the calculated critical path reduction is recorded (see operation 688), and if there are more selected techniques (e.g., techniques that can result in critical path reduction), then a next one is selected (see operation 690). In such a case, processing returns (see path 691) to apply the next technique (see operation 686). The loop continues until there are no more candidate critical path reduction techniques to apply, and processing proceeds to check if all resources demanded are scheduled to be fulfilled across the tasks of the reduced critical path (see operation 692).

In some cases, bringing in a task on a critical path also brings in successor tasks, and in the event that a successor task had demands for resources, the act of bringing in a critical path task has the effect of also bringing in the timing of the demands from successor tasks. The flow of system 600 includes steps for remediation in such cases. For example, and as shown, if the check that all resources demanded are scheduled to be fulfilled across the tasks of the reduced critical path fails (e.g., see decision 693 and path 695) then the flow returns to an earlier point to remediate the affected tasks (see path 695 and start point 681). In some cases, all resource demands are satisfied, and the flow proceeds (see endpoint 694).

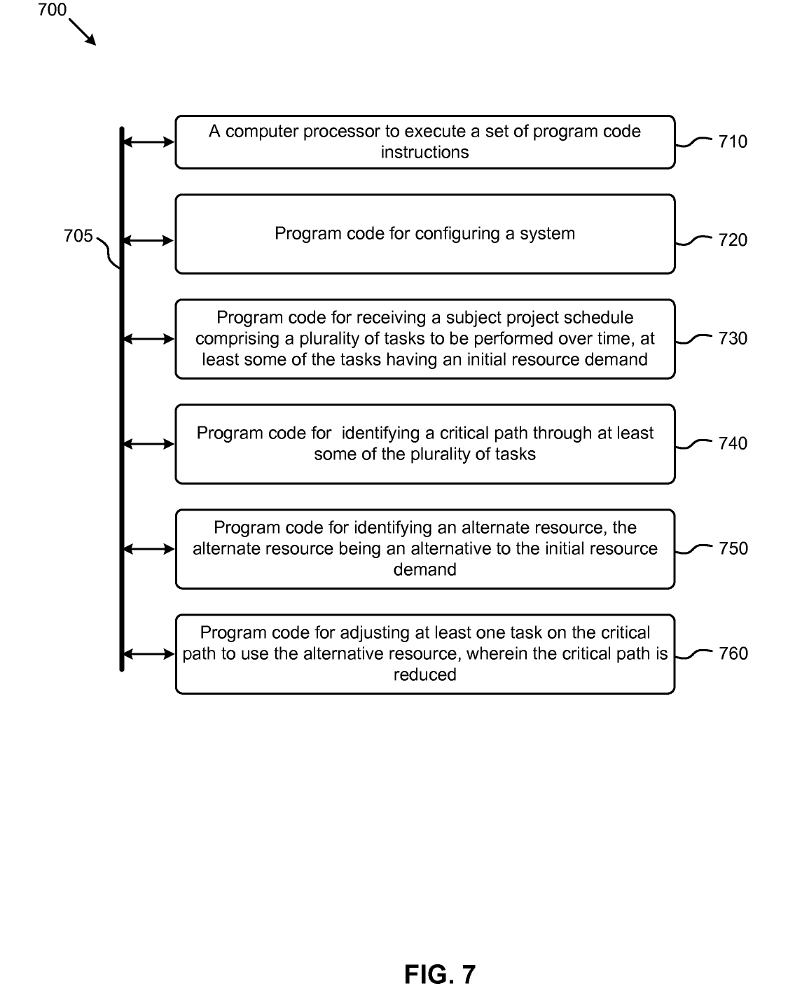

FIG. 7 is a block diagram of a system for reducing critical paths using risk-aware project scheduling techniques. As an option, the present system 700 may be implemented in the context of the architecture and functionality of the embodiments described herein. Of course, however, the system 700 or any operation therein may be carried out in any desired environment.

As shown, system 700 comprises at least one processor and at least one memory, the memory serving to store program instructions corresponding to the operations of the system. As shown, an operation can be implemented in whole or in part using program instructions accessible by a module. The modules are connected to a communication path 705, and any operation can communicate with other operations over communication path 705. The modules of the system can, individually or in combination, perform method operations within system 700. Any operations performed within system 700 may be performed in any order unless as may be specified in the claims.

The embodiment of FIG. 7 implements a portion of a computer system, shown as system 700, comprising a computer processor to execute a set of program code instructions (see module 710) and modules for accessing memory to hold program code instructions for configuring a computing system having at least one processor to perform a process (see module 720), the process comprising: receiving a subject project schedule comprising a plurality of tasks to be performed over time, at least some of the tasks having an initial resource demand (see module 730); identifying a critical path through at least some of the plurality of tasks (see module 740); identifying an alternate resource, the alternate resource being an alternative to the initial resource demand (see module 750); and adjusting at least one task on the critical path to use the alternative resource, wherein the critical path is reduced (see module 760).

The system 700 implements identifying the time-wise availability of the alternative resource. In some cases, the identified resource is a resource from a project schedule other than the received subject project schedule. In some cases, the identified resource is selected from a resource pool.

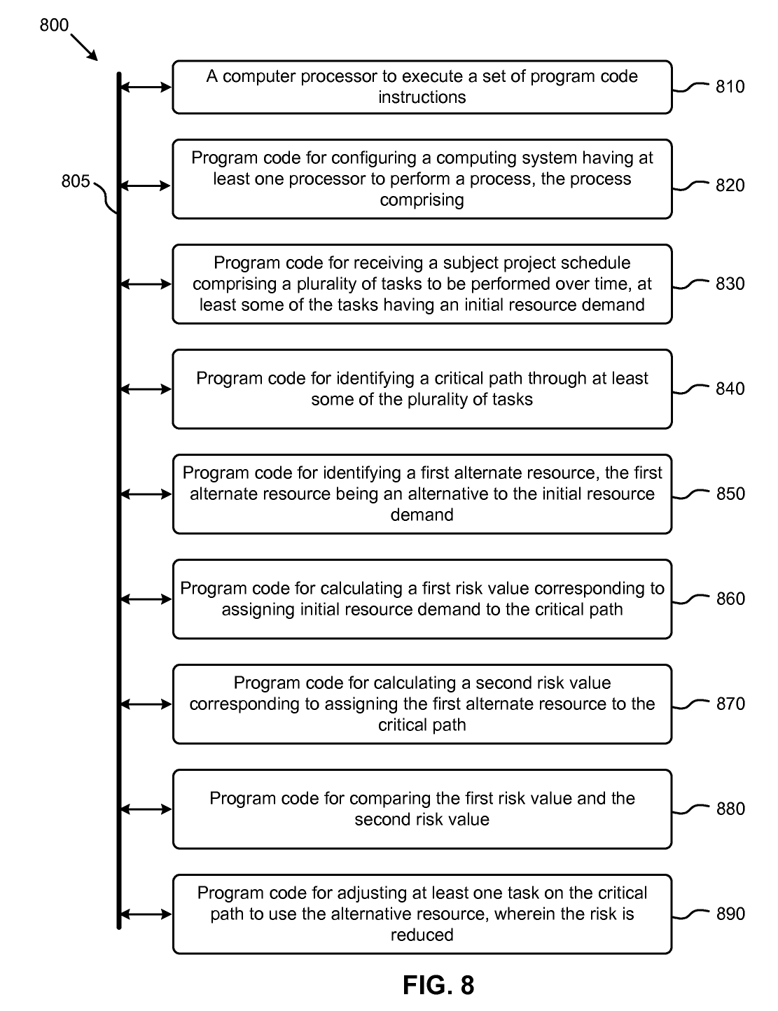

FIG. 8 is a block diagram of a system for reducing critical paths using risk-aware project scheduling techniques. As an option, the present system 800 may be implemented in the context of the architecture and functionality of the embodiments described herein. Of course, however, the system 800 or any operation therein may be carried out in any desired environment.

As shown, system 800 comprises at least one processor and at least one memory, the memory serving to store program instructions corresponding to the operations of the system. As shown, an operation can be implemented in whole or in part using program instructions accessible by a module. The modules are connected to a communication path 805, and any operation can communicate with other operations over communication path 805. The modules of the system can, individually or in combination, perform method operations within system 800. Any operations performed within system 800 may be performed in any order unless as may be specified in the claims.

The embodiment of FIG. 8 implements a portion of a computer system, shown as system 800, comprising a computer processor to execute a set of program code instructions (see module 810) and modules for accessing memory to hold program code instructions to perform: using a computing system having at least one processor to perform a process, the process comprising (see module 820); receiving a subject project schedule comprising a plurality of tasks to be performed over time, at least some of the tasks having an initial resource demand (see module 830); identifying a critical path through at least some of the plurality of tasks (see module 840); identifying a first alternate resource, the first alternate resource being an alternative to the initial resource demand (see module 850); calculating a first risk value corresponding to assigning initial resource demand to the critical path (see module 860); calculating a second risk value corresponding to assigning the first alternate resource to the critical path (see module 870); comparing the first risk value and the second risk value (see module 880); and adjusting at least one task on the critical path to use the alternative resource, wherein the risk is reduced (see module 890).

### System Architecture Overview

### Additional System Architecture Examples

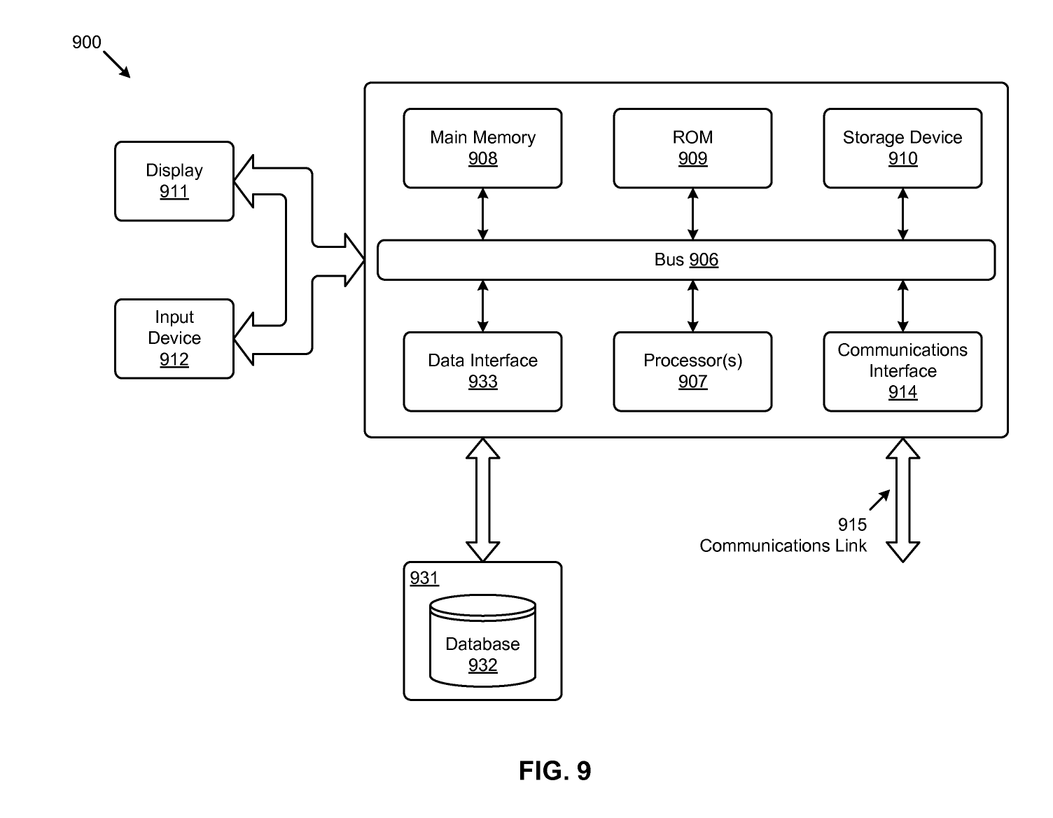

FIG. 9 depicts a block diagram of an instance of a computer system 900 suitable for implementing an embodiment of the present disclosure. Computer system 900 includes a bus 906 or other communication mechanism for communicating information, which interconnects subsystems and devices, such as a processor 907, a system memory 908 (e.g., RAM), a static storage device (e.g., ROM 909), a disk drive 910 (e.g., magnetic or optical), a data interface 933, a communication interface 914 (e.g., modem or Ethernet card), a display 911 (e.g., CRT or LCD), input devices 912 (e.g., keyboard, cursor control), and an external data repository 931.

According to one embodiment of the disclosure, computer system 900 performs specific operations by processor 907 executing one or more sequences of one or more instructions contained in system memory 908. Such instructions may be read into system memory 908 from another computer readable/usable medium, such as a static storage device or a disk drive 910. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 907 for execution. Such a medium may take many forms, including but not limited to, non-volatile media and volatile media. Non-volatile media includes, for example, optical or magnetic disks, such as disk drive 910. Volatile media includes dynamic memory, such as system memory 908.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 900. According to certain embodiments of the disclosure, two or more computer systems 900 coupled by a communications link 915 (e.g., LAN, PTSN, or wireless network) may perform the sequence of instructions required to practice the disclosure in coordination with one another.

Computer system 900 may transmit and receive messages, data, and instructions, including programs (e.g., application code), through communications link 915 and communication interface 914. Received program code may be executed by processor 907 as it is received, and/or stored in disk drive 910 or other non-volatile storage for later execution. Computer system 900 may communicate through a data interface 933 to a database 932 on an external data repository 931. A module as used herein can be implemented using any mix of any portions of the system memory 908, and any extent of hard-wired circuitry including hard-wired circuitry embodied as a processor 907.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A method comprising:
using a computing system having at least one processor to perform a process, the process comprising:
receiving a subject project schedule comprising a plurality of tasks to be performed over time, at least some of the tasks having an initial resource demand;
identifying a critical path through at least some of the plurality of tasks;
identifying a first alternate resource, the first alternate resource being an alternative to the initial resource demand;
calculating a first path risk value corresponding to assigning initial resource demand to the critical path;
calculating a second path risk value corresponding to assigning the first alternate resource to the critical path;
comparing the first path risk value and the second path risk value; and
adjusting at least one task on the critical path to form an adjusted critical path using a less risky alternative resource.

2. The method of claim 1, further comprising calculating a third path risk value corresponding to assigning a second alternate resource to the critical path.

3. The method of claim 1, wherein identifying the first alternate resource includes identifying a time-wise availability of the alternative resource.

4. The method of claim 1, wherein identifying a first available resource includes identifying availability of a resource from a project schedule other than the received subject project schedule.

5. The method of claim 4, further comprising using one or more units of the resource from the project schedule other than the received subject project schedule to the critical path of the received subject project schedule to reduce the received subject project schedule duration.

6. The method of claim 1, wherein comparing the first path risk value and the second path risk value includes using at least one tie breaking rule.

7. The method of claim 1, further comprising calculating a slack time between the adjusted critical path and the critical path of the received subject project schedule to form a time-wise risky path value.

8. The method of claim 1, wherein calculating the second path risk value includes accessing a resource request date.

9. The method of claim 1, wherein calculating the second path risk value includes accessing a priority value.

10. The method of claim 1, wherein the first alternate resource is selected from a resource pool.

11. A computer program product embodied in a non-transitory computer readable medium, the computer readable medium having stored thereon a sequence of instructions which, when executed by a processor causes the processor to execute a process, the process comprising:
receiving a subject project schedule comprising a plurality of tasks to be performed over time, at least some of the tasks having an initial resource demand;
identifying a critical path through at least some of the plurality of tasks;
identifying a first alternate resource, the first alternate resource being an alternative to the initial resource demand;
calculating a first path risk value corresponding to assigning initial resource demand to the critical path;
calculating a second path risk value corresponding to assigning the first alternate resource to the critical path;
comparing the first path risk value and the second path risk value; and
adjusting at least one task on the critical path to form an adjusted critical path using a less risky alternative resource.

12. The computer program product of claim 11, further comprising instructions for calculating a third path risk value corresponding to assigning a second alternate resource to the critical path.

13. The computer program product of claim 11, wherein identifying the first alternate resource includes identifying a time-wise availability of the alternative resource.

14. The computer program product of claim 11, wherein identifying a first available resource includes identifying availability of a resource from a project schedule other than the received subject project schedule.

15. The computer program product of claim 14, further comprising instructions for using one or more units of the resource from the project schedule other than the received subject project schedule to the critical path of the received subject project schedule to reduce the received subject project schedule duration.

16. The computer program product of claim 11, wherein comparing the first path risk value and the second path risk value includes using at least one tie breaking rule.

17. The computer program product of claim 11, further comprising instructions for calculating a slack time between the adjusted critical path and the critical path of the received subject project schedule to form a time-wise risky path value.

18. The computer program product of claim 11, wherein calculating the second path risk value includes accessing a resource request date.

19. A system comprising:
a planning module configured to receiving a subject project schedule comprising a plurality of tasks to be performed over time, at least some of the tasks having an initial resource demand;
a critical path calculator to identify a critical path through at least some of the plurality of tasks, and to identify a first alternate resource, the first alternate resource being an alternative to the initial resource demand;
a first portion of resource assignment logic to calculate a first path risk value corresponding to assigning initial resource demand to the critical path, nd to calculate a second path risk value corresponding to assigning the first alternate resource to the critical path;
a second portion of resource assignment logic to compare the first path risk value and the second path risk value; and
a resource scheduler to adjust at least one task on the critical path to form an adjusted critical path using a less risky alternative resource.

20. The system of claim 19, wherein identifying a first available resource includes identifying availability of a resource from a project schedule other than the received subject project schedule.
